(19) United States
(12) Patent Application Publication
(10) Pub. No.: US 2004/0149858 A1
(43) Pub. Date: Aug. 5, 2004

(54) Airplane security system

(76) Inventor: Warren Marshall, Nanuet, NY (US)

Correspondence Address: FURGANG & ADWAR, 2 CROSFIELD AVENUE, WEST NYACK, NY, 10994

(21) Appl. No.: 10/196,700

(22) Filed: Jul. 16, 2002

(51) Int. Cl. B64D 11/00

(52) U.S. Cl. 244/118.5

(57) ABSTRACT

The security system has a control. The control is attached to an actuator for emergency crash landing purposes and a manual controller. The controller is attached to a plurality of tethers, each having a fork at its terminal end. The fork is attached to several types of security devices. When the control is actuated, tension on the tethers causes the forks to become dislodged from the mechanisms to which they attach. Once dislodged, the mechanism are disabled, allowing easy access through the cockpit door. In this manner, security of the cockpit is insured, yet will not inhibit the crew's safety in the event of an emergency.

### FIELD OF THE INVENTION

The invention relates to a security system for aircraft doors.

### BACKGROUND OF THE INVENTION

There is always a need to secure the cockpit of an aircraft. The security system must allow easy access to authorized personnel, yet prevent all other access. Also, the system must allow quick exit by the cockpit crew in the event of a crash landing.

Currently cockpit doors are not designed to be structurally sound. They are relatively thin and flexible, making them susceptible to forced entry. The doors are provided with conventional locks, including bolts entering the bulkhead at the end of a door, opposite the hinges. The hinges are of conventional structure, attaching the cockpit door to the bulkhead. While the conventional locking mechanism provides security to the cockpit door, they present a hindrance to the quick exit from the cockpit by the crew in the event of an emergency landing.

The prior art discloses several types of bolts to secure a door. U.S. Pat. No. 4,379,577 (Robertson) discloses a latch bolt strike lock. The slidable bolt has a recess 62. The bolt enters the door frame DF and is retained by a locking plate 40 having a tab 44 that fits into the recess. The locking plate is perpendicular to the sliding bolt.

U.S. Pat. No. 3,591,219 (Graziosi) discloses a safety door lock having a swinging arm 12 with an aperture 42. Locking bolts 56 have cylindrical section 60 spring biased through the aperture 42. U.S. Pat. No. 4,746,152 (Wilcox) discloses a door lock having a sliding bolt 32 with an aperture 40. A locking pin is spring biased through the aperture 40 to retain the sliding bolt in a locked position.

### SUMMARY OF THE INVENTION

The security system has a controller. The controller is attached to an actuator for emergency crash landing purposes and a manual override. A plurality of tethers, each having a fork at its terminal end, are attached to the controller. The forks are attached to several types of security devices. When the controller is actuated, tension is created on the tethers to cause the forks to become dislodged from the mechanisms to which they attach. Once dislodged, the mechanism are disabled, allowing easy access through the cockpit door. In this manner, security of the cockpit is insured, yet will not inhibit the crew's safety in the event of an emergency.

A cockpit security device comprises a bulkhead having an entrance with a door closing said entrance. A pair of supports on the door slidably retain a bolt by said pair of supports. A rod rigidly connects to and extends between the pair of supports. A bracket rigidly connects to said bolt, the rod passing through the bracket. A stop is on said rod and a spring extends between one of the supports and the stop. A spring restrained from moving by the stop. The spring is able to move the stop and apply force against the bracket to disengage the bolt from said bulkhead.

A cockpit security system comprises a motion sensing device and a plurality of tethers extending from the motion sensing device, each tether terminating in a fork. The forks are attachable to security devices.

A cockpit security comprises a door for closing an entrance in a bulkhead and a hinge attached to the door to allow rotational motion of said door. The hinge comprises a knuckle having a diameter and a housing extends from the knuckle. The housing has a width smaller than said knuckle diameter. A pin retained in the knuckle has a reduced neck portion. The reduced neck portion has a width smaller than the housing width and a depth greater than the housing width. The pin is moved from the knuckle into the housing when the door is closed and a force is applied to the door.

A cockpit security device comprises a bulkhead having an entrance and a door closing the entrance. A hinge attached to the door and the bulkhead allows rotational motion of the door. The hinge comprises a pair of cups, one of said cups located above the door and the other of the cups located below the door.

A mounting housing is retained within each of said cups and a wire is retained by and extends between said mounting housings. A guide on said door retained the wire to attach the wire to the door so that the door pivots about the wire. The mounting housing are releasable from the cups.

A hinge attached to the door to allow rotational motion of said door. The hinge comprises a knuckle having a diameter and a housing extends from the knuckle. The housing has a width smaller than said knuckle diameter. A pin retained in the knuckle has a reduced neck portion. The reduced neck portion has a width smaller than the housing width and a depth greater than the housing width. The pin is moved from the knuckle into the housing when the door is closed and a force is applied to the door.

A cockpit security device comprises a bulkhead having an entrance and a cockpit door closing the entrance. A bolt is slidable mounted on the door. A guide tube in the bulkhead houses a spring within the guide tube. The spring is biased against the bolt. The guide tube allows for limited motion of the door in response to a force applied to the door. The spring returns the door to its original position upon removal of the force.

A cockpit security device comprises a bulkhead having an entrance and a cockpit door closing said entrance. At least one connection between the bulkhead and the cockpit door retains the door in a closed position. There are means for removing the at least one connection to allow for the door to fall from the entrance.

It is an object of the invention to provide a security system for aircraft doors.

It is another object of the invention to provide a security system which disables the safety mechanisms in the event of an emergency landing.

It is another object of the invention to provide a security system preventing unauthorized access to the cockpit.

It is yet another object of the invention to provide a security system which utilizes several mechanisms for providing security.

It is still another object of the invention to provide a security system that is easy to install and retrofit existing aircraft.

These and other objects of the invention will become apparent to one of ordinary skill in the art after reviewing the disclosure of the invention.

### BRIEF DESCRIPTION OF THE DRAWINGS

FIG. 1 is a view of the control for the security system;

FIG. 1A is a detailed view of the end of the controller;

FIG. 2 is a view of the actuator for the controller;

FIG. 3 is a view of the bolt for securing the cockpit door;

FIG. 4 is a top view of the bolt for the cockpit door with the securing device;

FIG. 5 is a side view of the bolt for the cockpit door;

FIG. 6 is a view of a hinge wire for the cockpit door;

FIG. 7 is a detailed view of the housing for the wire hinge;

FIG. 8 is a cross-sectional top view of a hinge knuckle for a cockpit door;

FIG. 9A is a side view of the hinge pin for the cockpit door; and

FIG. 9B is a front view of the hinge for the cockpit door.

### DETAILED DESCRIPTION OF THE INVENTION

The invention prevents unauthorized entry into the cockpit of an aircraft. The combination of the bolt lock and hinge of the invention allows the cockpit door to linearly move a short distance under the application of force. When the force is removed, the door returns to its original position under the force of springs. The invention also provides for the removal of all connections between the cockpit door and bulkhead to allow for the quick exit of the flight crew under emergency conditions. A motion detector governs the removal of the connections.

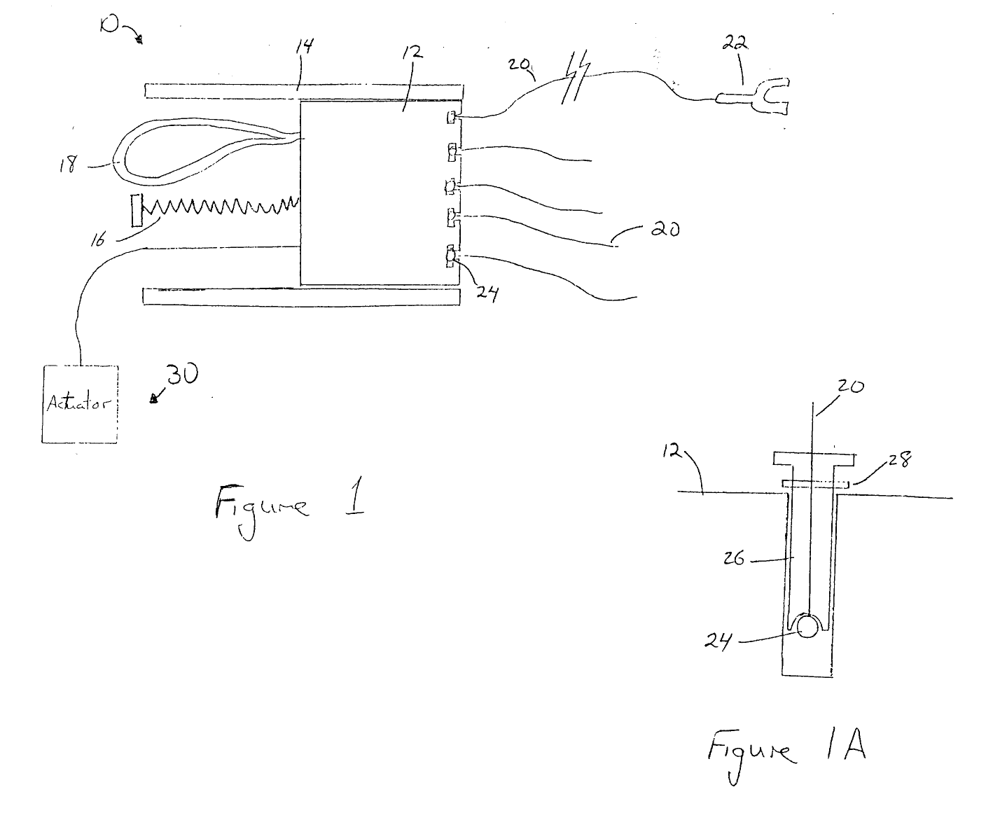

FIG. 1 shows the controller for the security system. The controller has a block 12 retained for reciprocal motion within sliders 14. The block is retained in a right-most position by the bias of a spring 16.

A plurality of tethers 20 extend from the right side of the block. Each tether is attached to a fork 22. The purpose and function of the fork is described hereinafter. The block 12 can be moved to the left by one of two mechanism. A lanyard 18 extends from the left side of the block and can be manually grasped and pulled to move the block to the left. Also, a tether 20 extends to an actuator 30. The function and structure of the tether is described later. When a force is applied by either the lanyard or by the actuator, the bias of the spring 16 is overcome and the block moves to the left. The movement of the block creates tension on the tethers 20 to dislodge the fork 22.

The connection of the tethers to the block 12 is shown in FIG. 1A. The block 12 has a series of recesses into which plungers 26 are threadedly received. The plunger 26 has a central passage through which a tether passes. The tether 20 terminates in a bead 24 retained at the bottom of the plunger 26. When the plunger 26 is threadedly engaged with the recess of the block 12, the tethers 20 are secured. A lock nut 28 attached to the body of the plunger 26 inhibits the movement of the plunger 26 over time.

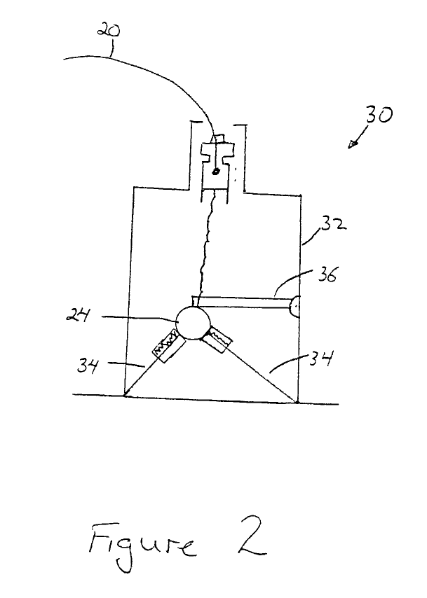

The structure of the actuator 30 is clearly seen in FIG. 2. The actuator 30 has a housing 32 into which a tether 20 extends. A bead 24 is suspended between supports 34 and an arm 36. The arm 36 is pivotally attached to the side of the housing 32. Under forces exerted by such action as a emergency landing, the bead 34 will be displaced from its equilibrium position due to the movement of the arm 36. The bead 26 will drop and apply tension to the tether 20. This tension causes the block 12 to move to the left.

A top view of a cockpit door and bulkhead is seen in FIG. 3. In the view, the door 50 is provided with ballistic resistant material 56. On the inside of the door, a pair of supports 54 support a bolt 52. The bolt 52 is free for reciprocal motion within the supports 54. The end of the bolt 52 extends into bulkhead 40. The bolt 52 extends through a slot in the edge of the bulkhead 40. The bulkhead 40 has a guide tube 42 housing a spring 44. The spring 44 terminates in a strike plate 46. The spring biases the strike plate against the bolt 52. If force is applied against the outside of the door, the door will move into the cockpit compressing the spring 44 until the bolt 52 reaches the end of the slot. In this manner, the door 50 will move a small distance in reaction to an external force. However, the travel distance of the door is limited by the bolts traveling within the slot.

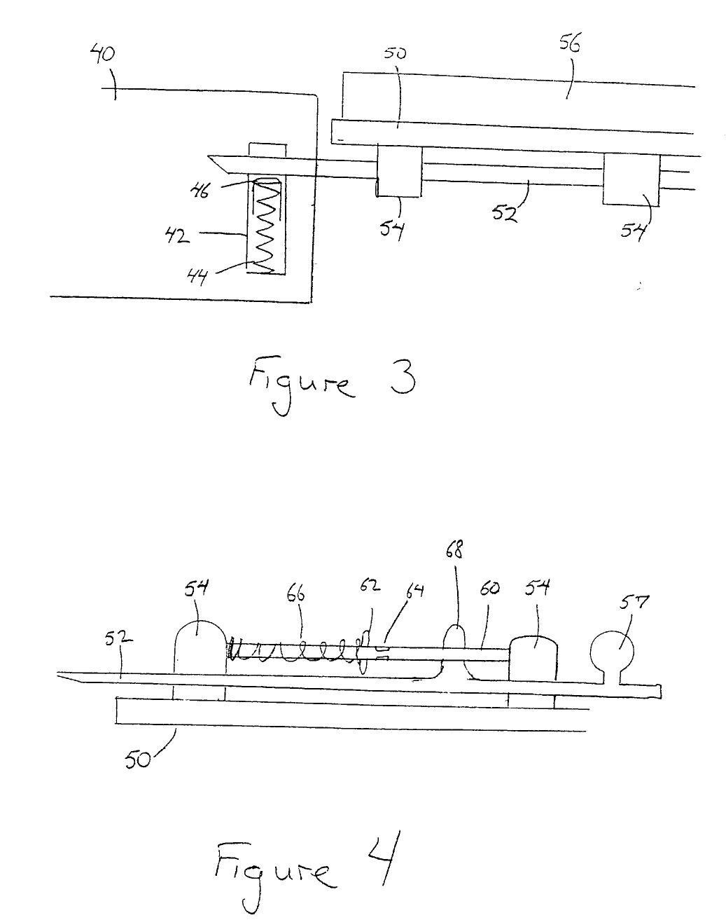

FIG. 4 shows a security system for the door bolt. The bolt 52 is provided with a handle 57 for the manual retraction of the bolt 52 from the bulkhead. A rod 60 is rigidly attached and extends between the two supports 54. The rod 60 has a collar 62 and a notch 64. The collar 62 freely moves along the bolt 52. The notch 64 retains a fork 22. When the fork is in place, the collar 62 is impeded from movement. A spring 66 extends between a support 54 and the collar 62. When the fork is removed by increased tension in its tether 20 as described earlier, the spring extends and pushes the collar until it reaches bracket 68 rigidly attached to the bolt 52. When the collar 62 reaches the bracket 68, force provided by the spring 66 pushes the bracket 68, and therefore pushes the bolt 52, to retract the bolt from the bulkhead. The side view of the bolt, supports and rod, are seen in FIG. 5.

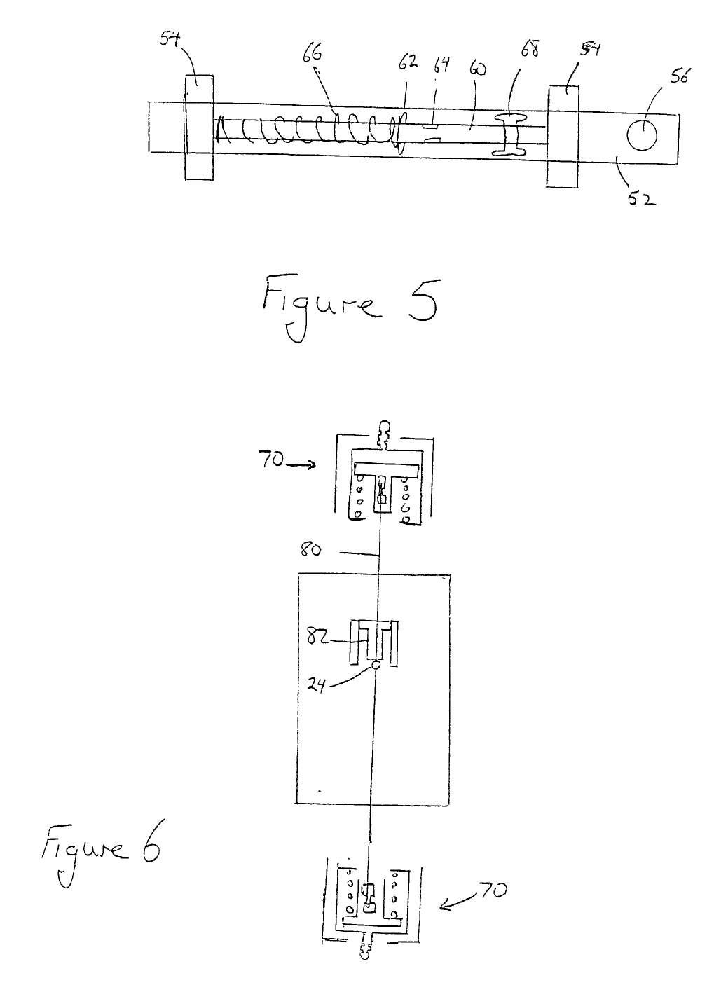

Turning now to FIG. 6, a hinge mechanism for a cockpit door is illustrated. The system uses a pair of housings 70 located in the floor and bulkhead of the cockpit. A wire 80 extends between the upper and lower housings 70. The door has at least one guide through which the wire 80 passes so that the door is able to pivot about the wire which acts as a hinge. The guide consists of a bolt 82 through which the wire 80 passes. The bolt is retained to the door by supports 83. A bead 24 allows tension to be applied to the bolt 82.

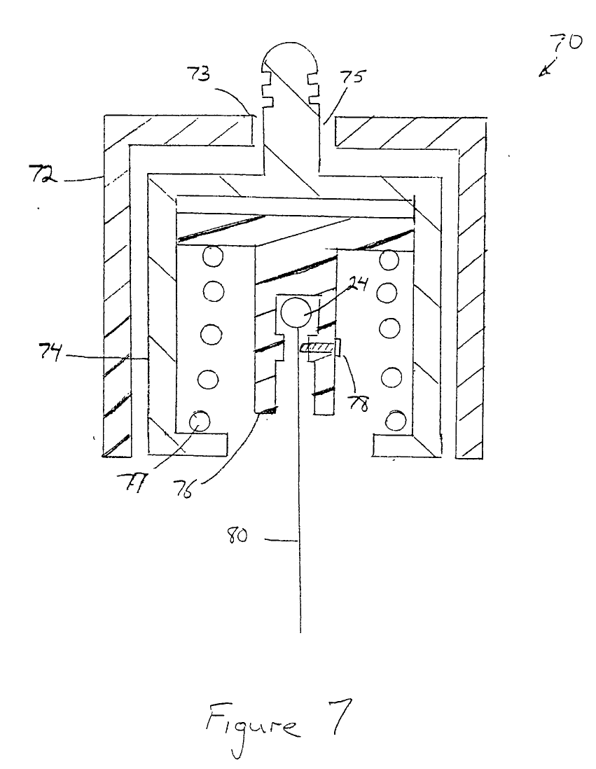

The detail of the upper and lower housing is seen with reference to FIG. 7. The housing has a cup 72 provided with a central aperture 73. A mounting housing 74 is received within the cup 72. A stem 75 on the mounting housing extends through the central aperture 73 of the cup 72. A plunger 76 is retained within the mounting housing 74. A spring 77 provides tension on the plunger to bias it in the direction of the stem 75. The plunger retains the wire 80 terminating in a bead 24. A set screw 78 within the body of the plunger prevents rotation of the wire 80.

The stem 73 is provided with notches. A fork engages the notches and retains the mounting housing in its position relative to the cup 72. In the event of an emergency landing that causes tension on the tethers 20 to dislodge the fork 22, the assembly of the mounting housing 74 and plunger 76 separate from the cup. All tension on the wire 80 will thereby be lost and the cockpit door would no longer be provided any support from the wire 80. This allows the cockpit crew to easily move the cockpit door from the access opening. If the door is provided with a series of bolts 52 as described earlier, no support at all will be provided to the door and it will simply fall to the floor and out of the way of the cockpit crew wishing to leave the cockpit.

A second type of hinge that can be used on the cockpit door is shown in FIG. 8. FIG. 8 is a cross-sectional top view of knuckle 84 having a housing with smaller dimensions than the knuckle 84 extending from the knuckle 84. In use, the housing would be perpendicular to the door. Within the housing is a spring 88 whose function will be described hereinafter. Brackets 89 extend from the knuckle for attaching the hinge to the bulkhead and the cockpit door.

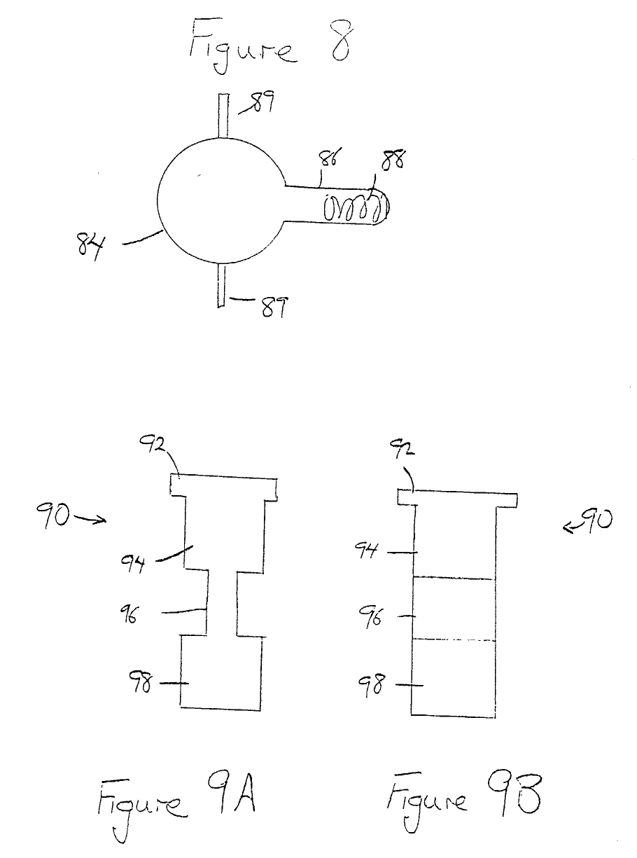

The hinge pin 90 useable with the knuckle of FIG. 8 is shown in FIG. 9A. FIG. 9A shows the side view as is seen at the pin 90 has a head 92, a top section 94 having a square cross-section, a middle neck portion having a width smaller than the top section and slightly smaller than the width of the housing 86. Bottom section 98 has a round cross-section.

The side view of the pin is seen in FIG. 9B. In this view, it is seen that the middle neck portion 96 has a depth equal to both the top square section 94 and bottom round section 98. The import of this is that when the door is in the closed position, the width of the middle neck portion is aligned with the housing 86. When in the open position, the pin is rotated so that the depth of the middle neck portion 96 prevents the entry of the pin into the housing 86. In the event that a force is applied to the exterior of the cockpit door when closed and the bolt 52 travels within the slot, as previously described, the edge of the door opposite the bolt 52 with the hinge will also be able to travel a lateral distance into the cockpit. The spring 88 in the housing 86 returns the pin to its original position within the knuckle 84.

The various systems useable with the forks 22 actuated by the controller 10 previously described result in a security system for preventing unauthorized access to a cockpit, but allowing the quick exit of the cockpit crew in the event of an emergency landing. The various components can be used alone or in combination as the user desires.

While the invention has been described with reference to preferred embodiments, variations and modifications would be apparent to one of ordinary skill in the art without departing from the scope of the invention. Consequently, the invention is not to be limited to the exact embodiments but encompasses these variations and modifications and by the appended claims.

I claim:

1. A cockpit security device comprising:
a bulkhead having an entrance,
a door closing said entrance,
a pair of supports on said door, a bolt slidably retained by said pair of supports, and engaging said bulkhead,
a rod rigidly connected to and extending between said pair of supports,
a bracket rigidly connected to said bolt, said rod passing through said bracket,
a stop on said rod,
a spring extending between one of said supports and said stop, said spring restrained from moving by said stop,
whereby, said spring is able to move said stop and apply force against said bracket to disengage said bolt from said bulkhead.

2. The cockpit security device of claim 1, wherein said stop is a collar

3. The cockpit security device of claim 2, further comprising a notch formed in said rod for retaining a fork.

4. The cockpit security device of claim 1, further comprising ballistic resistant material on said door.

5. The cockpit securing device of claim 1, wherein said stop is a fork.

6. The cockpit security device of claim 1, further comprising:
a guide tube in said bulkhead,
a spring housed within said guide tube, said spring biased against said bolt,
said guide tube allowing for limited motion of said door in response to a force applied to said door, said spring returning the door to its original position upon removal of the force.

7. The cockpit security device of claim 6, further comprising a strike plate at the end of the spring, said strike plate contacting said bolt.

8. The cockpit security device of claim 1, further comprising a handle on said bolt for manual movement of said bolt.

9. The cockpit security device of claim 1, further comprising:
a hinge attached to said door and said bulkhead to allow rotational motion of said door, said hinge comprising:
a knuckle having a diameter,
a housing extending from said knuckle, said housing having a width smaller than said knuckle diameter,
a pin retained in said knuckle, said pin having a reduced neck portion, said reduced neck portion having a width small than said housing width and a depth greater than said housing width,
whereby, said pin is moved from said knuckle into said housing when the door is closed and a force is applied to said door.

10. The cockpit security device of claim 9, further comprising a spring retained in said housing for returning said pin into said knuckle upon removal of the force.

11. The cockpit security device of claim 9, wherein said pin comprises a top section having a square cross-section, a middle reduced neck portion and a bottom section having a round cross-section.

12. A cockpit security system comprising:
a motion sensing device,
a plurality of tethers extending from said motion sensing device, each tether terminating in a fork,
said forks attachable to security devices.

13. The cockpit security device of claim 12, wherein
said motion sensing device comprises
a pair of rails,
a block slidably retained by said rails, said block biased toward one end of said rails, and
an actuator for moving said block against said bias to create tension
in said tethers and dislodge said forks from said security devices

14. The cockpit security device of claim 13, wherein said block is biased by a spring.

15. The cockpit security device of claim 12, further comprising:
a bulkhead having an entrance,
a door closing said entrance,
a pair of supports on said door, a bolt slidably retained by said pair of supports, and engaging said bulkhead,
a rod rigidly connected to and extending between said pair of supports,
a bracket rigidly connected to said bolt, said rod passing through said bracket,
a collar slidably retained on said rod,
a notch formed in said rod for releasably retaining one of said forks,
a spring extending between one of said supports and said collar, said collar restrained from moving by said fork,
whereby, when said fork is dislodged from said notch, said spring forces said collar against said bracket and applies force against said bracket to disengage said bolt from said bulkhead.

16. The cockpit security device of claim 15, further comprising ballistic resistant material on said door.

17. The cockpit security device of claim 15, further comprising:
a guide tube in said bulkhead,
a spring housed within said guide tube, said spring biased against said bolt,
said guide tube allowing for limited motion of said door in response to a force applied to said door, said spring returning the door to its original position upon removal of the force.

18. The cockpit security device of claim 17, further comprising a strike plate at the end of the spring, said strike plate contacting said bolt.

19. The cockpit security device of claim 15, further comprising a handle on said bolt for manual movement of said bolt.

20. The cockpit security device of claim 12, further comprising:
a bulkhead having an entrance,
a door closing said entrance,
a hinge attached to said door and said bulkhead to allow rotational motion of said door, said hinge comprising:
a knuckle having a diameter,
a housing extending from said knuckle, said housing having a width smaller than said knuckle diameter,
a pin retained in said knuckle, said pin having a reduced neck portion, said reduced neck portion having a width small than said housing width and a depth greater than said housing width,
whereby, said pin is moved from said knuckle into said housing when the door is closed and a force is applied to said door.

21. The cockpit security device of claim 20, further comprising a spring retained in said housing for returning said pin into said knuckle upon removal of the force.

22. The cockpit security device of claim 12, further comprising:
a bulkhead having an entrance,
a door closing said entrance,
a hinge attached to said door and said bulkhead to allow rotational motion of said door, said hinge comprising:
a pair of cups, one of said cups located above said door and the other of said cups located below said door,
a mounting housing retained within each of said cups
a wire retained by and extending between said mounting housings,
a guide on said door, said wire retained by said guide to attach said wire to said door so that said door pivots about said wire,
said mounting housing releasable from said cups.

23. The cockpit security device of claim 22, further comprising:
an aperture in each of said cups,
a stem on each of said mounting housings, said stems extending through said apertures,
one of said forks engaging said stem to hold the mounting housing relative to said cup,
whereby, upon the increase in tension in said tether attached to said fork, said fork disengages said stem and said mounting housing is released from cup.

24. The cockpit security device of claim 23, further comprising:
a plunger in said mounting housing, said plunger attached to said wire,
a spring biasing said plunger toward said stem of said mounting housing.

25. The cockpit security system of claim 22, wherein
said guide is a bolt secured to said door, said bolt having a central passage, said wire passing through said central passage.

26. A cockpit security, comprising:
a door for closing an entrance in a bulkhead,
a hinge attached to said door and said bulkhead to allow rotational motion of said door, said hinge comprising:
a knuckle having a diameter,
a housing extending from said knuckle, said housing having a width smaller than said knuckle diameter,
a pin retained in said knuckle, said pin having a reduced neck portion, said reduced neck portion having a width smaller than said housing width and a depth greater than said housing width,
whereby, said pin is moved from said knuckle into said housing when the door is closed and a force is applied to said door.

27. The cockpit security device of claim 26, further comprising a spring retained in said housing for returning said pin into said knuckle upon removal of the force.

28. The cockpit security device of claim 26, wherein said pin comprises a top section having a square cross-section, a middle reduced neck portion and a bottom section having a round cross-section.

29. A hinge, comprising:
a knuckle having a diameter,
a housing extending from said knuckle, said housing having a width smaller than said knuckle diameter,
a pin retained in said knuckle, said pin having a reduced neck portion, said reduced neck portion having a width small than said housing width and a depth greater than said housing width,
whereby, said pin is moved from said knuckle into said housing when a door is closed and a force is applied to the door.

30. The hinge of claim 29, further comprising a spring retained in said housing for returning said pin into said knuckle upon removal of the force.

31. The hinge of claim 29, wherein said pin comprises a top section having a square cross-section, a middle reduced neck portion and a bottom section having a round cross-section.

32. A cockpit security device comprising,
a bulkhead having an entrance,
a door closing said entrance,
a hinge attached to said door and said bulkhead to allow rotational motion of said door, said hinge comprising:
a pair of cups, one of said cups located above said door and the other of said cups located below said door,
a mounting housing retained within each of said cups
a wire retained by and extending between said mounting housings,
a guide on said door, said wire retained by said guide to attach said wire to said door so that said door pivots about said wire,
said mounting housing releasable from said cups.

33. The cockpit security device of claim 32, further comprising:
an aperture in each of said cups,
a stem on each of said mounting housings, said stems extending through said apertures,
one of said forks engaging said stem to hold the mounting housing relative to said cup,
whereby, upon the increase in tension in said tether attached to said fork, said fork disengages said stem and said mounting housing is released from cup.

34. The cockpit security device of claim 33, further comprising:
a plunger in said mounting housing, said plunger attached to said wire,
a spring biasing said plunger toward said stem of said mounting housing.

35. The cockpit security system of claim 32, wherein
said guide is a bolt secured to said door, said bolt having a central passage, said wire passing through said central passage.

36. A cockpit security device comprising:
a bulkhead having an entrance,
a cockpit door closing said entrance,
a bolt slidable mounted on said door,
a guide tube in said bulkhead,
a spring housed within said guide tube, said spring biased against said bolt,
said guide tube allowing for limited motion of said door in response to a force applied to said door, said spring returning the door to its original position upon removal of the force.

37. The cockpit security device of claim 36, further comprising a strike plate at the end of the spring, said strike plate contacting said bolt.

38. The cockpit security device of claim 36, further comprising a handle on said bolt for manual movement of said bolt.

39. The cockpit security device of claim 36, further comprising:
a hinge attached to said door and said bulkhead to allow rotational motion of said door, said hinge comprising:
a knuckle having a diameter,
a housing extending from said knuckle, said housing having a width smaller than said knuckle diameter,
a pin retained in said knuckle, said pin having a reduced neck portion, said reduced neck portion having a width small than said housing width and a depth greater than said housing width,
whereby, said pin is moved from said knuckle into said housing when the door is closed and a force is applied to said door.

40. The cockpit security device of claim 39, further comprising a spring retained in said housing for returning said pin into said knuckle upon removal of the force.

41. The cockpit security device of claim 39, wherein said pin comprises a top section having a square cross-section, a middle reduced neck portion and a bottom section having a round cross-section.

42. The cockpit security device of claim 36, wherein said cockpit door comprises ballistic resistant material.

43. A cockpit security device comprising:
a bulkhead having an entrance,
a cockpit door closing said entrance,
at least one connection between said bulkhead and said cockpit door for retaining the door in a closed position, and
means for removing said at least one connection to allow for the door to fall from said entrance.

44. The cockpit security device of claim 43, wherein
said at least one connection is a bolt slidable mounted on said door.

45. The cockpit security device of claim 43, wherein
said at least one connection is a hinge mounted on said door.

46. The cockpit security device of claim 43, wherein
said means for removing said at least one connection is a motion detector.

47. The cockpit security device of claim 46, wherein
said motion detector comprises:
a pair of rails,
a block slidably retained by said rails, said block biased toward one end of said rails,
At least one tether extending from said block, and
an actuator for moving said block against said bias to create tension in said tethers and dislodge said forks from said security devices

48. The cockpit security device of claim 47, wherein said block is biased by a spring.
